(19) United States
(12) Patent Application Publication
(10) Pub. No.: US 2003/0125031 A1
(43) Pub. Date: Jul. 3, 2003

(54) Method for managing resources differentially in partitioned service zone of cell in wireless mobile communication system

(76) Inventors: Jae Sung Lim, Suwon-si (KR); Sung Yun Yun, Suwon-si (KR); Hyun Suk Lee, Suwon-si (KR); Ha Il Kim, Seoul (KR); Soon Jin Choi, Seoul (KR)

Correspondence Address: PERMAN & GREEN, 425 POST ROAD, FAIRFIELD, CT, 06824, US

(21) Appl. No.: 10/159,362

(22) Filed: May 31, 2002

(30) Foreign Application Priority Data
Dec. 28, 2001 (KR) 01-87286

(51) Int. Cl. H04Q 7/20

(52) U.S. Cl. 455/447; 455/453

(57) ABSTRACT

A method for managing resources in a wireless mobile communication system, wherein one cell is partitioned into a plurality of service zones where different services are provided, and the resources are allocated differentially to the partitioned service zones, thereby reducing interferences with neighbor cells and efficiently managing the resources. The resource management method comprises the first step of partitioning one cell into a plurality of service zones, the service zones being provided with different services from the system and proportional in number to types of the services, the second step of allowing a radio network controller allocating the resources to mobile stations, to determine which each of said mobile stations is located in any one of the service zones, and the third step of allowing the radio network controller to allocate the resources differentially to the mobile stations according to the determined service zones. In this manner, one cell is partitioned into a plurality of service zones provided with different services and system resources, such as a transmission rate and power, are allocated differentially to the partitioned service zones. Therefore, system performance and the using efficiency of radio resource can be increased and interferences with neighbor cells can be reduced.

### BACKGROUND OF THE INVENTION

1. Field of the Invention

The present invention relates to a method for managing resources in a mobile communication system of a code division multiple access (referred to hereinafter as CDMA), and more particularly to a method for managing resources in a wireless mobile communication system, wherein one cell is partitioned into a plurality of areas (referred to hereinafter as service zones) where different services are provided, and the resources are allocated differentially to the partitioned service zones, thereby reducing interferences with neighbor cells and efficiently managing the resources.

2. Description of the Related Art

FIG. 1 is a schematic view illustrating a conventional method for allocating resources in a CDMA mobile communication system. In the CDMA mobile communication system, as shown in FIG. 1, a base transceiver station BTS allocates resources equally to all mobile stations MN1-MN5 in the radius of one cell. The base transceiver station BTS can maintain a sufficient quality of service (QoS) of a mobile station (for example, MN1) nearer thereto by merely transmitting data with a smaller amount of power to the mobile station. Alternatively, the base transceiver station BTS must transmit data with a larger amount of power to mobile stations (for example, MN5 and MN4) in the vicinity of the cell border (namely, farther from the base transceiver station BTS) to maintain QoS of the mobile stations.

However, in such a conventional power control scheme for providing a larger amount of power to mobile stations on the cell border, as shown in FIG. 2, a base transceiver station BTS1 of a cell CELL1 may cause interferences with mobile stations MN2-MN7 located in other cells CELL2-CELL7 neighboring on the cell CELL1. Further, the base transceiver station BTS1 may be subject to interferences by signals from the mobile stations MN2-MN7 in the external cells CELL2-CELL7. These interferences result in degradation in reception performance of the base transceiver station BTS1 when the base transceiver station BTS1 receives signals transmitted from mobile stations in the cell CELL1 under the jurisdiction thereof.

In order to overcome the above problems, a base transceiver station has to allocate resources to all mobile stations in one cell managed thereby, in such a manner that it is minimized for base transceiver stations of other cells to be subject to interferences by signals from the mobile stations. It is the current reality that these interferences with the external cells are a critical problem with the CDMA mobile communication systems.

On the other hand, a radio network controller (RNC) is adapted to monitor the capacity of one cell continuously while managing the cell. If the cell capacity reaches an uppermost limit, then the RNC allocates no resources to a new mobile station until the amount of load on the cell is reduced. As a result, the new mobile station cannot communicate in such a cell whose capacity has reached the uppermost limit, until the amount of load on the cell is reduced.

A reuse partitioning method has been proposed in order to solve the above problem of the cell capacity. FIG. 3 illustrates a frequency-unit cell partition scheme based on the reuse partitioning method. In order to increase channel capacities of resources in a frequency division multiple access (FDMA) mobile communication system, as shown in FIG. 3, the reuse partitioning method is adapted to partition one cell into a plurality of zones ZONE_{—}1, ZONE_{—}2 and ZONE_{—}3 based on a plurality of frequencies F1, F2 and F3. The use of the different frequencies F1, F2 and F3 in the partitioned cell zones ZONE_{—}1, ZONE_{—}2 and ZONE_{—}3 can reduce interferences with neighbor cells. However, this method is not appropriate to the CDMA mobile communication system where all mobile stations share the same frequency band. Further, the cell partition based on the different frequencies may result in many frequency bands being occupied.

Such conventional techniques are disclosed in U.S. Pat. No. 6,229,796 (“Code-reuse partitioning systems and methods for cellular radio telephone systems”), U.S. Pat. No. 5,835,849 (“Cellular mobile radio system comprising sub-cells”), Kohji Takeo's paper, “Time Slot Assignment Using Cell Partitioning in CDMA Cellular Systems” (IEEE International conference on Communications, Vol. 5, 1381-1385, June, 2001), etc.

### SUMMARY OF THE INVENTION

Therefore, the present invention has been made in view of the above problems, and it is an object of the present invention to provide a method for partitioning one cell into a plurality of service zones where different services are provided and allocating a relatively small amount of resources to mobile stations located in an outer service zone of the cell, among the partitioned service zones, so as to reduce interferences with neighbor cells.

It is another object of the present invention to provide a method for, upon random access by a mobile station, setting a power value of an initial access preamble signal using information regarding a service zone to which the mobile station belongs, among a plurality of partitioned service zones of one cell, so as to shorten an access time.

It is yet another object of the present invention to provide a method for allocating a relatively large amount of resources to an inner-service zone nearer to a base transceiver station, among a plurality of partitioned service zones of one cell to increase the entire system throughput, and allocating system resources differentially to the partitioned service zones to manage the system resources more efficiently and increase a system capacity.

In accordance with one aspect of the present invention, the above and other objects can be accomplished by the provision of a method for managing resources in a wireless mobile communication system, comprising the steps of: a) partitioning one cell into a plurality of service zones, the service zones being provided with different services from the system and proportional in number to types of the services; b) allowing a radio network controller allocating the resources to mobile stations, to determine which each of the mobile stations is located in any one of the service zones; and c) allowing the radio network controller to allocate the resources differentially to the mobile stations according to the determined service zones.

In accordance with another aspect of the present invention, there is provided a method for managing resources in a wireless mobile communication system, comprising the steps of: a) partitioning one cell into a handoff service zone and a non-handoff service zone; b) allowing a radio network controller allocating the resources to mobile stations, to determine which each of the mobile stations is located in any one of the service zones; and c) allowing the radio network controller to allocate the resources differentially to the mobile stations according to the determined service zones.

In accordance with further another aspect of the present invention, there is provided a method for managing resources in a wireless mobile communication system, comprising the steps of: a) partitioning one cell into a plurality of service zones; b) allowing a radio network controller allocating the resources to mobile stations, to determine which each of the mobile stations is located in any one of the service zones; and c) allowing the radio network controller to allocate packet transmission priorities differentially to the mobile stations according to the determined service zones.

In accordance with yet another aspect of the present invention, there is provided a method for managing resources in a wireless mobile communication system, comprising the steps of: a) partitioning one cell into a plurality of service zones; b) allowing a radio network controller allocating the resources to mobile stations, to determine which each of the mobile stations is located in any one of the service zones; and c) allowing the radio network controller to allocate the resources and packet transmission priorities differentially to the mobile stations according to the determined service zones.

In accordance with still another aspect of the present invention, there is provided a method for performing access by mobile stations in one cell, comprising the steps of: a) partitioning the cell into a plurality of service zones; b) determining which each of the mobile stations is located in any one of the service zones; and c) allowing each of the mobile stations to determine initial access preamble signal power on the basis of associated service zone information and try randomly the access to a radio network controller with the determined initial access preamble signal power.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a conventional method for allocating resources in a code division multiple access (CDMA) mobile communication system;

FIG. 2 is a conceptual diagram illustrating interferences with neighbor cells in the CDMA mobile communication system;

FIG. 3 is a conceptual diagram illustrating a frequency-unit cell partition in a frequency division multiple access (FDMA) mobile communication system, based on a conventional reuse partitioning method;

FIGS. 4A and 4B are conceptual diagrams illustrating different embodiments of partitioning one cell into a plurality of service zones in accordance with the present invention;

FIGS. 5A and 5B are flow charts illustrating different embodiments of a method for partitioning one cell into a plurality of service zones and managing resources in the partitioned service zones in accordance with the present invention;

FIG. 6 is a conceptual diagram illustrating an example of partitioning one cell into two service zones and managing resources in the partitioned service zones in accordance with the present invention;

FIGS. 7(A) and 7(B) are timing diagrams illustrating a method for performing random access by a mobile station in accordance with the present invention; and

FIG. 8 is a flow chart illustrating the random access method in accordance with the present invention.

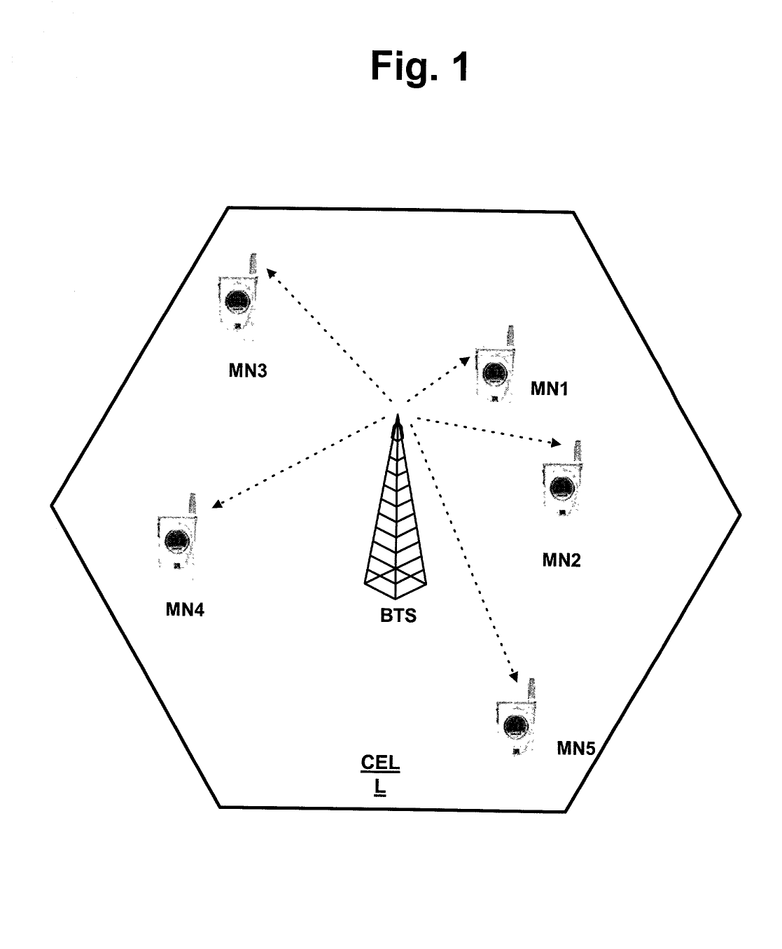

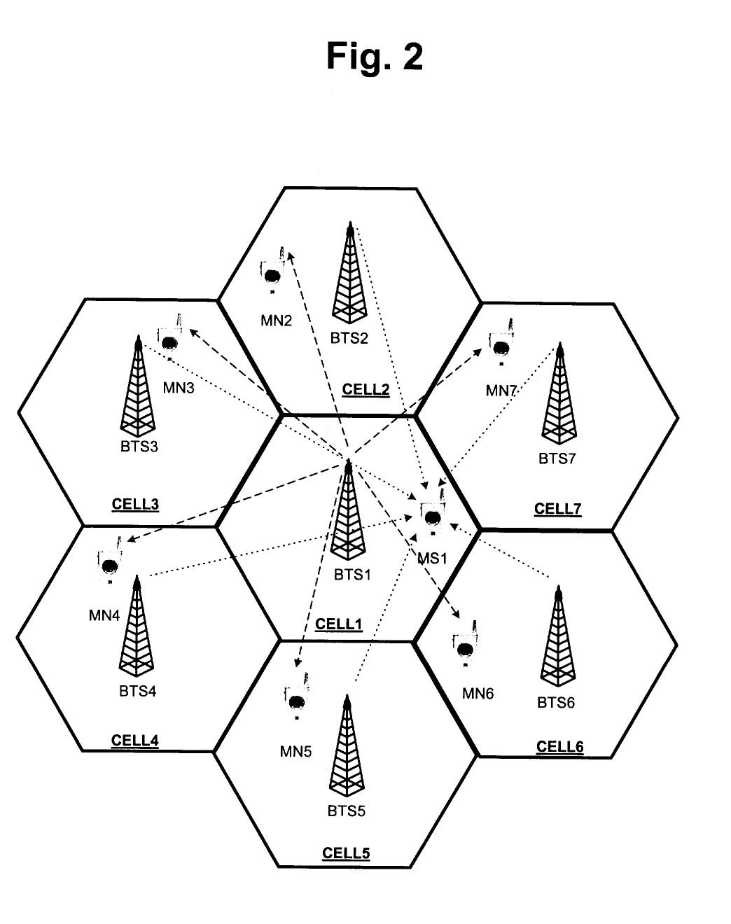

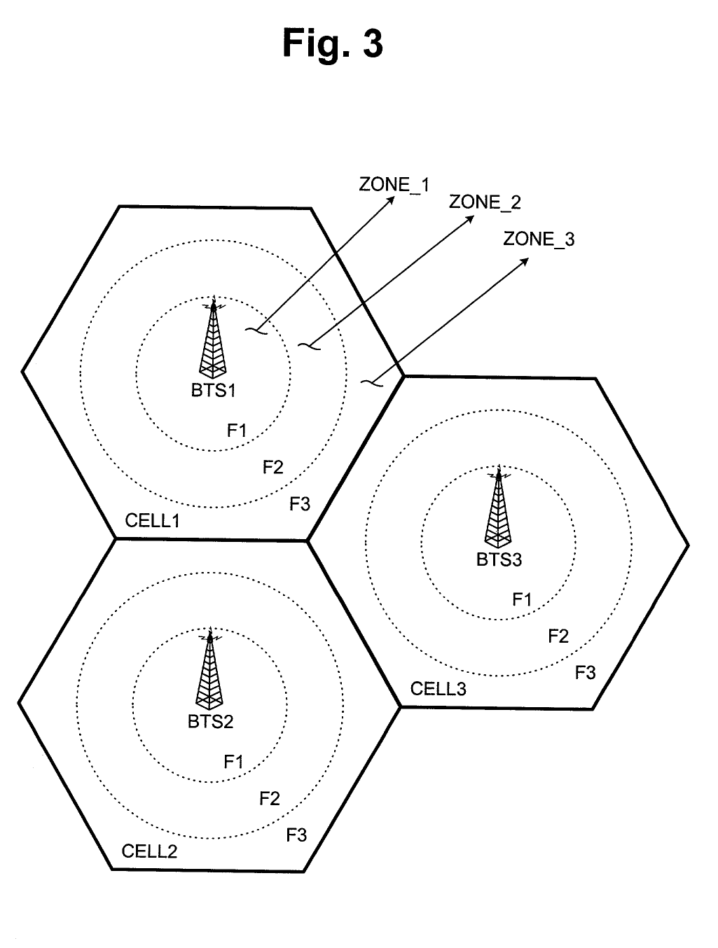

### DESCRIPTION OF THE PREFERRED EMBODIMENTS

Now, preferred embodiments of a method for managing resources differentially in a plurality of partitioned service zones of one cell in a wireless mobile communication system in accordance with the present invention will be described in detail with reference to the accompanying drawings.

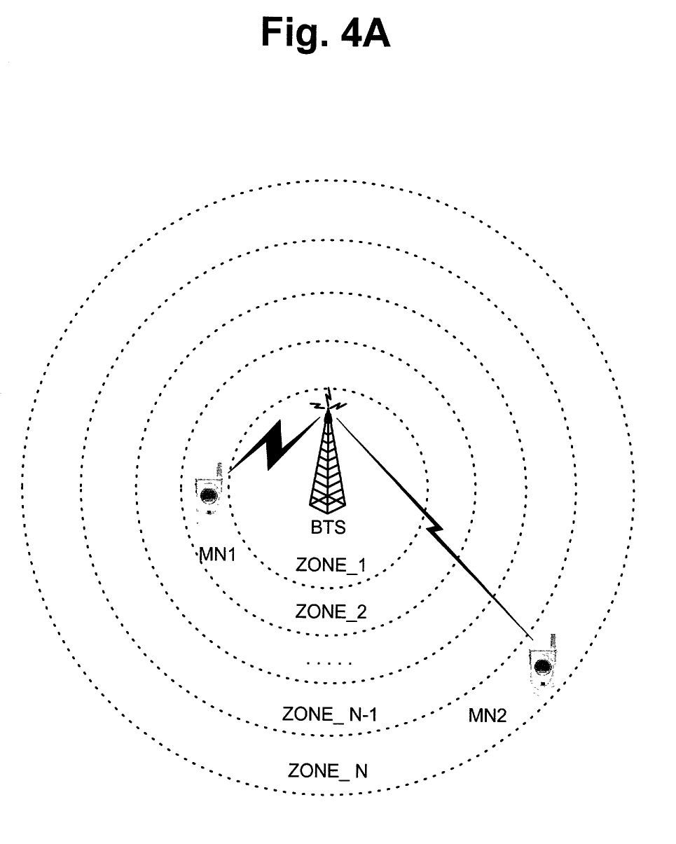

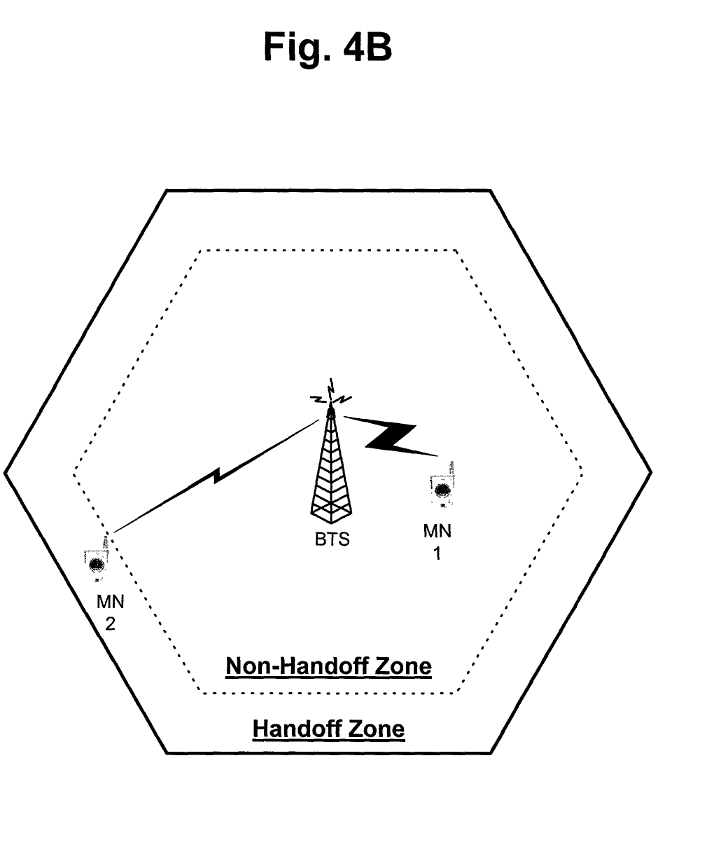

FIGS. 4A and 4B are conceptual diagrams illustrating different embodiments of partitioning one cell into a plurality of service zones in a wireless mobile communication system in accordance with the present invention. In this invention, the cell partition can be roughly classified into embodiment 1 (FIG. 4A) and embodiment 2 (FIG. 4B).

In the embodiment 1, as shown in FIG. 4A, one cell is partitioned into a plurality of service zones ZONE_{—}1, ZONE_{—}2, . . . ZONE_N−1, ZONE_N which are provided with different services from the system and proportional in number to types of the services. The service zones can be classified according to the types of the services provided by the system. That is, the number of the service zones is in proportion to the number of services prescribed in the system. The service types may be all services that can be provided from service providers to mobile stations via a base transceiver station, for example, a voice service, a short message service (SMS), a video on demand (VOD) service, a video conference service, an electronic commerce (E-commerce) service, a Web browsing service and so forth.

For example, only services occupying a smaller amount of resources, such as the voice service, the short message service and the like, are allocated to service zones (for example, ZONE_N, ZONE_N−1, etc.) farther from the base transceiver station BTS. Allocated to service zones (for example, ZONE_{—}1, ZONE_{—}2, etc.) nearer to the base transceiver station BTS are services requiring a larger amount of resources, such as the VOD service, the video conference service, the E-commerce service, the Web browsing service and the like, as well as the voice service and the short message service occupying the smaller amount of resources. To put it more concretely, with reference to the following Table 1, all services are provided in the service zone ZONE_{—}1, and the services provided in the service zone ZONE_{—}1, except for one (for example, the video conference service) to be allocated a largest amount of resources, are provided in the service zone ZONE_{—}2. Similarly, the services provided in the service zone ZONE_{—}2, except for one (for example, the VOD service) to be allocated a largest amount of resources, are provided in the service zone ZONE_{—}3. In this manner, one cell can be partitioned into service zones based on service categories.

TABLE 1

| SERVICE | |
|---|---|
| ZONES | SERVICES BEING PROVIDED |
| ZONE_1 | VOICE, SHORT MESSAGE, E-COMMERCE, WEB |
| | BROWSING, VOD AND VIDEO CONFERENCE |
| ZONE_2 | VOICE, SHORT MESSAGE, E-COMMERCE, WEB |
| | BROWSING AND VOD |
| ZONE_3 | VOICE, SHORT MESSAGE, E-COMMERCE AND WEB |
| | BROWSING |
| ZONE_4 | VOICE, SHORT MESSAGE AND E-COMMERCE |
| ZONE_5 | VOICE AND SHORT MESSAGE |

In the embodiment 2, as shown in FIG. 4B, one cell is partitioned into a non-handoff zone and a handoff zone, and resources are allocated differentially to the partitioned zones.

These embodiments may be selected according to mobile communication service providers' intentions.

According to the present invention, the resource management can be conducted by partitioning one cell into a plurality of service zones. There are various methods to perform the cell partition. All possible cell partition methods are applicable to the present invention as long as they do not depart from the scope and spirit of the invention. Three methods are proposed herein to partition one cell into a plurality of service zones.

1. Geographical Method

One cell can be geographically partitioned on the basis of the position of a base transceiver station antenna. Different cell partition units may be employed according to various types of existing cells. For example, one cell may be partitioned into a plurality of service zones at intervals of 100 m, 200 m or 300 m on the basis of the antenna position, and resources may be managed differentially in the resultant service zones.

In general terms, a base transceiver station broadcasts pilot signals with the same transmission power to all mobile stations in the same cell. Each mobile station receives pilot signals from the base transceiver station over pilot signals and then calculates a path loss value from the base transceiver station thereto. This path loss value is obtained by subtracting a pilot signal reception power value of each mobile station from a pilot signal transmission power value of the base transceiver station.

Each mobile station sends the calculated path loss value to the base transceiver station, which then calculates a distance to each mobile station on the basis of the sent path loss value. Thereafter, the base transceiver station determines, on the basis of the calculated distance, a service zone to which each mobile station belongs, and manages resources of each mobile station corresponding to the determined service zone.

For example, in the case where a cell has a radius of 1 Km, it may have a path loss of −130 dB on its border. In this case, the cell can be regularly partitioned into a plurality of service zones inwardly from its border at distances corresponding to path loss intervals of 20 dB, as in the below Table 2. Although the service zones have been partitioned at regular path loss intervals of 20 dB in the Table 2, they may be partitioned at path loss intervals of different values if necessary.

TABLE 2

| SERVICE ZONES | PATH LOSS VALUE RANGES |
|---|---|
| ZONE_1 | 0 dB˜−30 dB |
| ZONE_2 | −30 dB˜−50 dB |
| ZONE_3 | −50 dB˜−70 dB |
| ZONE_4 | −70 dB˜−90 dB |
| ZONE_5 | −90 dB˜−110 dB |
| ZONE_6 | −110 dB˜−130 dB |

2. Method Using Pilot Signal

A base transceiver station transmits a pilot signal and service zone partitioning information to each mobile station. The service zone partitioning information is used to allow each mobile station to determine an associated service zone according to a reception signal characteristic of the received pilot signal. Each mobile station checks the reception signal characteristic of the received pilot signal and compares the checked result with the service zone partitioning information. Then, each mobile station determines from the compared result a service zone to which it belongs, and notifies the base transceiver station of the determined service zone.

The service zone partitioning information may be created, for example, in the following manner. Namely, a cell area where a reception signal characteristic, that is, a reception signal-to-noise ratio (SNR), of a mobile station exceeds 10 dB with respect to the pilot signal transmitted from the base transceiver station is defined as a service zone ZONE_{—}1. A cell area where the reception SNR of the mobile station ranges from 10 dB to 8 dB is defined as a service zone ZONE_{—}2. In this manner, one cell can be partitioned into a plurality of service zones at regular SNR intervals of 2 dB, as in the below Table 3. Although the service zones have been partitioned at regular SNR intervals of 2 dB in the Table 2, they may be partitioned at SNR intervals of different values if necessary. Note that, because a minimum of quality of service (QoS) providable by the mobile station is −15 dB, no service can be provided in a cell area where the reception SNR of the mobile station is below −15 dB.

TABLE 2

| SERVICE ZONES | SNR RANGES |
|---|---|
| ZONE_1 | MORE THAN 10 dB |
| ZONE_2 | 8 dB˜10 dB |
| ZONE_3 | 6 dB˜8 dB |
| ZONE_4 | 4 dB˜6 dB |
| ZONE_5 | 2 dB˜4 dB |
| ZONE_6 | 0 dB˜2 dB |
| ZONE_7 | −2 dB˜0 dB |
| ZONE_8 | −4 dB˜−2 dB |
| ZONE_9 | −6 dB˜−4 dB |
| ZONE_10 | −8 dB˜−6 dB |
| ZONE_11 | −10 dB˜−8 dB |
| ZONE_12 | −12 dB˜−10 dB |
| ZONE_13 | −15 dB˜−12 dB |

3. Method Using Strength of Received Signal

All mobile stations in the same cell send messages evenly to a base transceiver station upon synchronization with the base transceiver station. The base transceiver station measures the strengths of signals sent from all the mobile stations and determines from the measured signal strengths service zones where the mobile stations are currently present, respectively.

By way of the above-described methods, a radio network controller (RNC) can recognize service zones where all mobile stations in one cell are currently present, respectively. That is, for forward control, a mobile station can measure the strength of a signal from a base transceiver station and determine from the measured result a service zone where it is currently located. For reverse control, the base transceiver station can measure the strength of a signal from the mobile station and determine from the measured result a service zone where the mobile station is currently located. At this time, the radio network controller allocates resources to the mobile station according to a resource management strategy in consideration of the current system capacity.

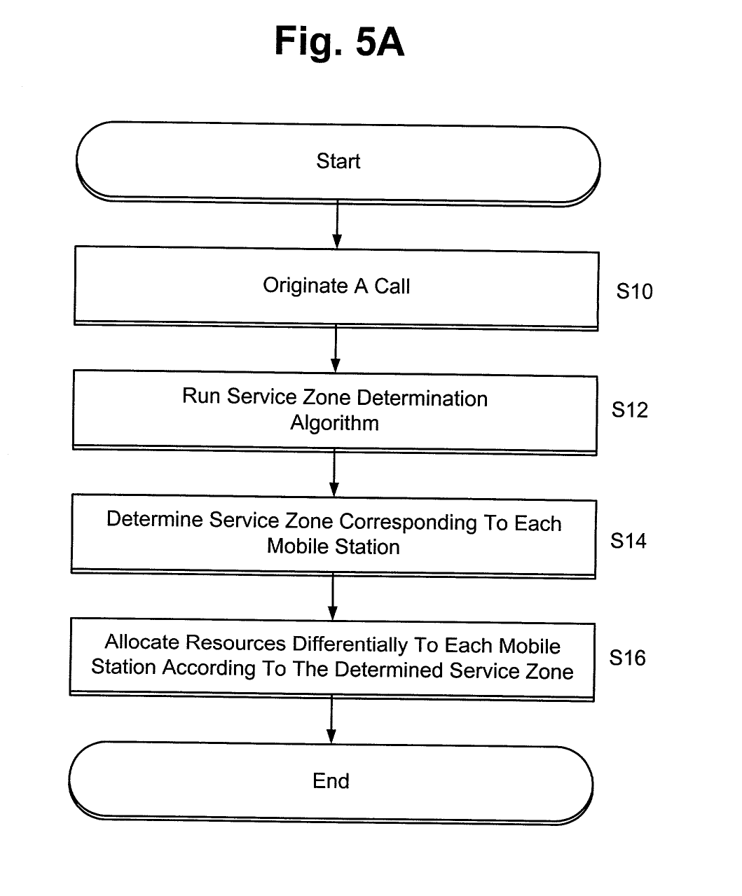

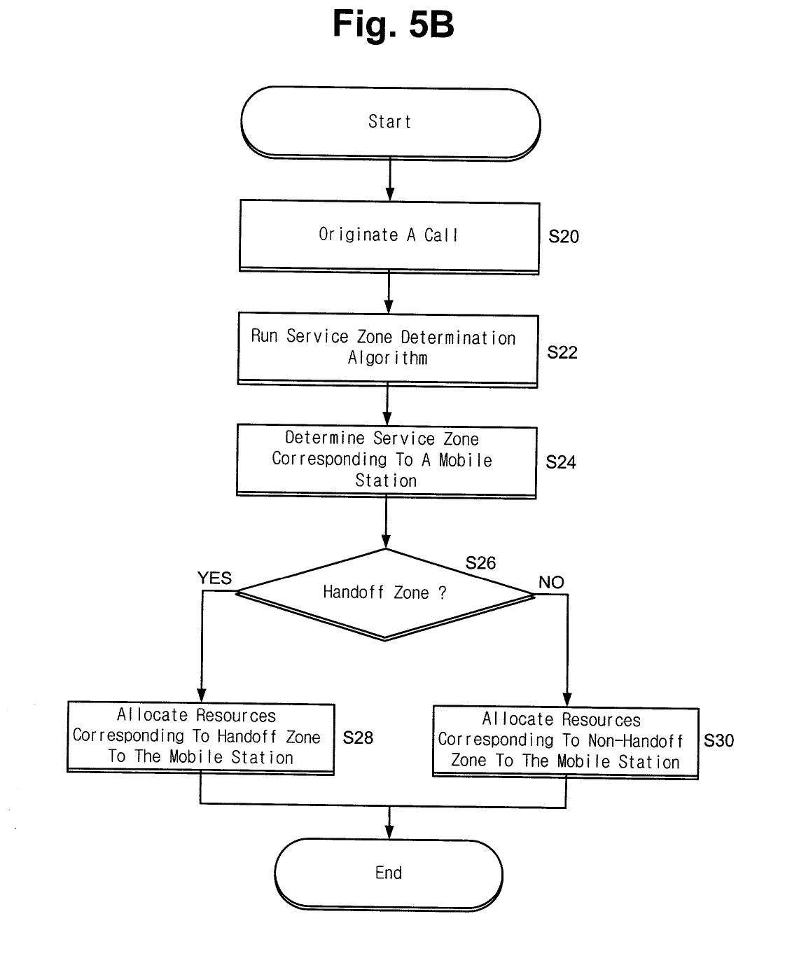

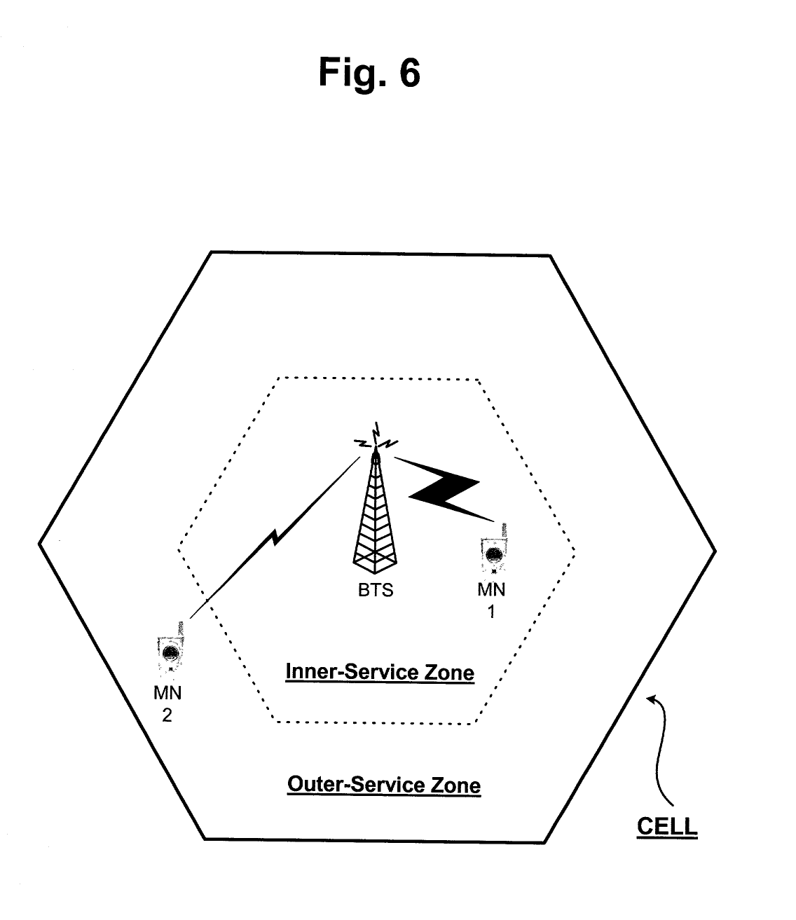

FIGS. 5A and 5B are flow charts illustrating different embodiments of a method for partitioning one cell into a plurality of service zones and managing resources in the partitioned service zones in accordance with the present invention, and FIG. 6 is a conceptual diagram illustrating an example of partitioning one cell into two service zones and managing resources in the partitioned service zones in accordance with the present invention. Although one cell will hereinafter be described to be partitioned into two service zones for the convenience and simplification of description, it should be noted that the present invention is not limited thereto and one cell can be partitioned into three or more service zones for better resource management.

With reference to FIGS. 5A and 6, first, if a call is originated in the system (step S10), then a radio network controller runs a service zone determination algorithm (step S12) to determine a service zone to which a mobile station originating the call belongs (step S14). At this time, the service zone determination is made according to the service zone determination algorithm. This service zone determination algorithm is performed on the basis of any one of the geographical method, the pilot signal-based method and the received signal strength-based method, or any other available method. Thereafter, the radio network controller assigns a service zone identification (ID) code to the determined service zone. On the basis of the service zone ID code, the radio network controller allocates resources differentially to the call originating mobile station according to whether the mobile station is present in an inner-service zone or an outer-service zone (step S16). That is, the radio network controller allocates a larger amount of resources to the mobile station when it is present in the inner-service zone, and a smaller amount of resources to the mobile station when it is present in the outer-service zone. As a result, the resources can be efficiently managed, thereby reducing interferences with neighbor cells and increasing the entire system throughput.

Next, with reference to FIGS. 5B and 6, first, if a call is originated in the system (step S20), then a radio network controller runs a service zone determination algorithm (step S22) to determine a service zone to which a mobile station originating the call belongs (step S24). At this time, the service zone is determined to be any one of a handoff zone and a non-handoff zone. Thereafter, the radio network controller assigns a service zone identification (ID) code to the determined service zone. On the basis of the service zone ID code, the radio network controller allocates resources differentially to the call originating mobile station according to whether the mobile station is present in the handoff zone or non-handoff zone (steps S26 to S30). That is, the radio network controller allocates a large amount of resources to the mobile station when it is present in the non-handoff zone, and a relatively small amount of resources to the mobile station when it is present in the handoff zone.

In the above-described embodiments of the present invention, a packet scheduling method may be performed as an alternative to the method of providing resources differentially to mobile stations according to service zones where the mobile stations are located. The packet scheduling method is performed to assign a higher packet transmission priority to a mobile station nearer to a base transceiver station, whereas to assign a lower packet transmission priority to a mobile station farther from the base transceiver station.

Assume that packets are transferred to a base transceiver station and then stored in a queue thereof. In this case, a packet of a mobile station located in the service zone ZONE_{—}1 (see FIG. 4A) is transferred earlier than a packet of a mobile station located in the service zone ZONE_{—}2 (see FIG. 4A). Namely, this algorithm is adapted to increase a throughput of the service zone ZONE_{—}1 by assigning a higher priority to the packet of the mobile station located in the service zone ZONE_{—}1 than that to the packet of the mobile station located in the service zone ZONE_{—}2. For example, in the case where one cell is partitioned into three service zones, that is, the service zone ZONE_{—}1, the service zone ZONE_{—}2 and the service zone ZONE_{—}3, a packet of the service zone ZONE_{—}1 can be transmitted earlier than packets of the service zones ZONE_{—}2 and ZONE_{—}3 by assigning priorities to the service zones ZONE_{—}1-ZONE_{—}3 in the order of 5:3:2. Furthermore, the differentiation among the service zones can be more enhanced by assigning priorities to the service zones ZONE_{—}1-ZONE_{—}3 in the order of 6:3:1.

This packet scheduling method can replace the resource allocation method to obtain the same effect.

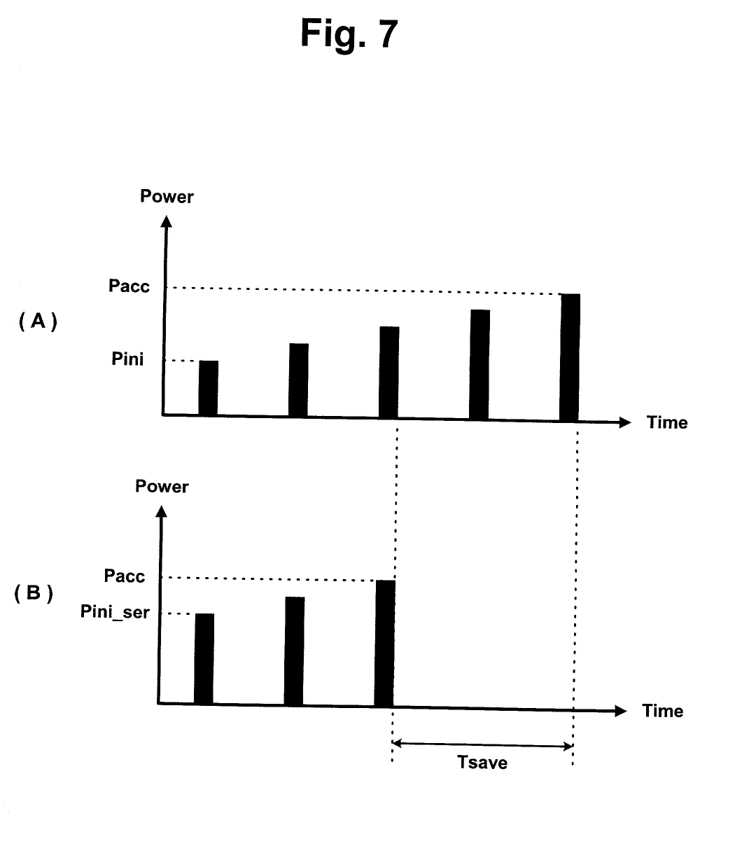

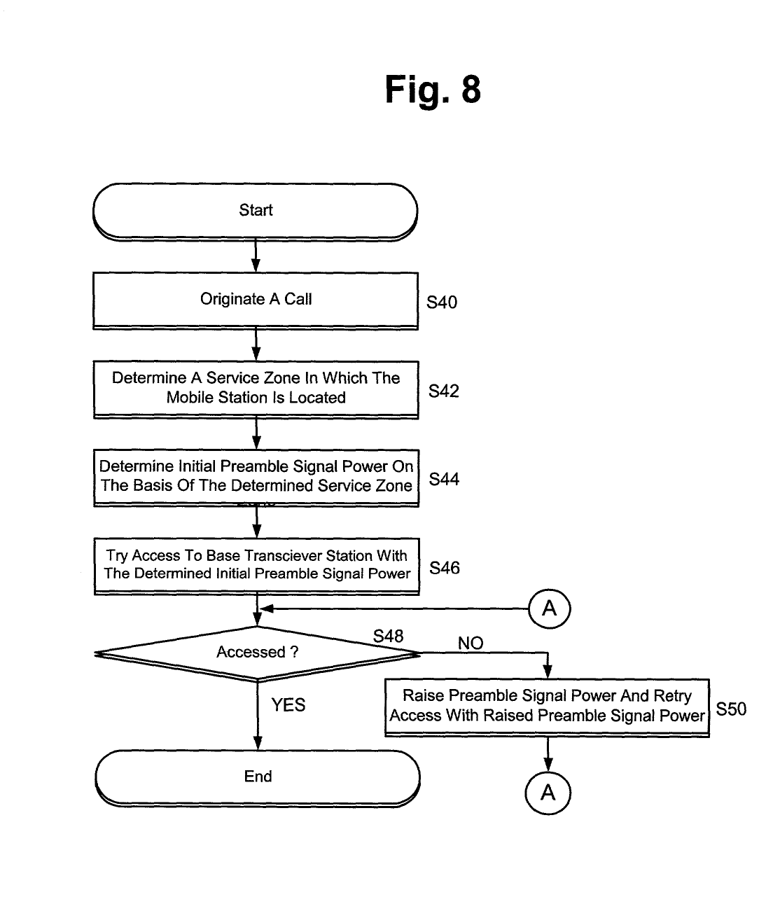

Next, a description will be given of a method for performing random access by a mobile station in accordance with another embodiment of the present invention with reference to FIGS. 7(A) to 8. FIGS. 7(A) and 7(B) show a shortened access time as a result of the comparison between the present random access method and a conventional random access method.

In the conventional random access method, as shown in FIG. 7(A), a mobile station transmits an initial access preamble signal to a base transceiver station using an existing random access preamble signal scheme. If the mobile station fails to access the base transceiver station, then it raises power by a certain amount and retries the access with the raised power until it accesses the base transceiver station. The initial preamble signal power is Pini and the access preamble signal power is Pacc.

In the present random access method, as shown in FIG. 8, if a mobile station originates a new call (step S40), then it determines a service zone where it is located (step S42). As stated previously, such a service zone is set by a radio network controller in a base transceiver station according to a service zone determination algorithm. The radio network controller transmits to each mobile station service zone information containing various data necessary to each mobile station in each service zone, such as position determination data for determination of a service zone where each mobile station is located, initial preamble signal setting power data for each service zone, etc. Each mobile station receives the service zone information transmitted from the radio network controller and stores it in a storage area.

Thereafter, the call originating mobile station determines initial access preamble signal power Pini_ser on the basis of associated service zone information (step S44) and transmits a preamble signal with the determined power to access the base transceiver station (step S46). If the mobile station fails to access the base transceiver station, then it raises the power by a certain amount and retries the access with the raised power until it accesses the base transceiver station (steps S48 to S50).

In the present random access method, when the call originating mobile station is located in the service zone ZONE_{—}1, it can sufficiently access the base transceiver station even though the initial access preamble signal power Pini_ser is low in level. The reason is that the presence of the mobile station in the service zone ZONE_{—}1 signifies that the mobile station is in the vicinity of the base transceiver station and the access preamble signal power Pacc is thus low in level. Alternatively, when the mobile station is located in the service zone ZONE_N, the initial access preamble signal power Pini_ser must be relatively high in level. The reason is that the presence of the mobile station in the service zone ZONE_N signifies that the mobile station is far from the base transceiver station and the access preamble signal power Pacc is thus high in level. Provided that the mobile station is located in the service zone ZONE_N and tries the access with the low initial access preamble signal power, it will have to try the access many times, resulting in an increase in access time. In this regard, the more accurate and rapid determination of the initial access preamble signal power can shorten the access time by Tsave as compared with the conventional method.

In accordance with another embodiment of the present invention, the present invention can be applied to a 1× EV-DO (1× Evolution-Data Only) system. In the 1× EV-DO system, if a mobile station determines the state of a currently estimated channel and sends a transmission rate indicator (transmission rate information) to a base transceiver station over a data rate channel (DRC), then the base transceiver station controls a data transmission rate within the range of 38.4 Kbps to 2,4576 Kbps according to the sent transmission rate indicator. At this time, the base transceiver station can vary the data transmission rate at different rates on the basis of service zone information proposed in the present invention. That is, the base transceiver station more rapidly increases the transmission rate with respect to a mobile station in a service zone nearer thereto, and more abruptly reduces the transmission rate with respect to a mobile station in a service zone farther therefrom. Further, the base transceiver station may set limits on the transmission rate according to service zone positions so that the service provision is impossible when the transmission rate is above or below the limits.

In accordance with yet another embodiment of the present invention, the resource allocation can be conducted on the basis of two basic elements, a transmission rate and transmission power. Namely, a high transmission rate and high power are provided to a mobile station located in an inner-service zone to raise a service throughput, and a relatively low transmission rate and relatively low power are provided to a mobile station located in an outer-service zone to reduce interferences with external cells.

Therefore, a radio network controller can more efficiently manage resources by providing the resources differentially to a plurality of service zones in one cell, resulting in an increase in system capacity.

As apparent from the above description, the present invention provides a method for partitioning one cell into a plurality of service zones where different services are provided and allocating a relatively small amount of resources to mobile stations located in an outer service zone of the cell, among the partitioned service zones, so as to reduce interferences with neighbor cells.

Further, according to the present invention, a relatively large amount of resources are allocated to mobile stations located in an inner-service zone to increase the entire system throughput.

Furthermore, according to the present invention, each mobile station determines initial access preamble signal power on the basis of associated service zone information to try random access. As a result, rapid access time can be assured.

Therefore, a radio network controller can more efficiently manage resources by providing the resources differentially to a plurality of service zones in one cell, resulting in an increase in system capacity and, in turn, an increase in the number of subscribers being accommodated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for managing resources in a wireless mobile communication system, comprising the steps of:
a) partitioning one cell into a plurality of service zones, said service zones being provided with different services from said system and proportional in number to types of said services;
b) allowing a radio network controller allocating said resources to mobile stations, to determine which each of said mobile stations is located in any one of said service zones; and
c) allowing said radio network controller to allocate said resources differentially to said mobile stations according to the determined service zones.

2. The method as set forth in claim 1, wherein said step c) includes the step of providing at least one service occupying a small amount of resources to ones of said mobile stations located in any one of said service zones farther from a base transceiver station, and providing at least one service occupying a relatively large amount of resources, together with said service occupying the small amount of resources, to ones of said mobile stations located in any one of said service zones nearer to said base transceiver station.

3. A method for managing resources in a wireless mobile communication system, comprising the steps of:
a) partitioning one cell into a handoff service zone and a non-handoff service zone;
b) allowing a radio network controller allocating said resources to mobile stations, to determine which each of said mobile stations is located in any one of said service zones; and
c) allowing said radio network controller to allocate said resources differentially to said mobile stations according to the determined service zones.

4. The method as set forth in claim 3, wherein said step c) includes the step of allocating a relatively large amount of resources to ones of said mobile stations located in said non-handoff service zone nearer to a base transceiver station.

5. A method for managing resources in a wireless mobile communication system, comprising the steps of:
a) partitioning one cell into a plurality of service zones;
b) allowing a radio network controller allocating said resources to mobile stations, to determine which each of said mobile stations is located in any one of said service zones; and
c) allowing said radio network controller to allocate packet transmission priorities differentially to said mobile stations according to the determined service zones.

6. The method as set forth in claim 5, wherein said step c) includes the step of allocating a relatively high packet transmission priority to ones of said mobile stations located in any one of said service zones nearer to a base transceiver station.

7. The method as set forth in any one of claims 1 to 6, wherein said step a) includes the step of partitioning said service zones geographically on the basis of a position of an antenna of a base transceiver station corresponding to the cell.

8. The method as set forth in claim 7, wherein said step b) includes the step of calculating a distance to each of said mobile stations on the basis of pilot signal reception power of each of said mobile stations with respect to pilot signal transmission power from said base transceiver station and determining on the basis of the calculated distance which one of said service zones corresponds to each of said mobile stations.

9. The method as set forth in any one of claims 1 to 6, wherein said step b) includes the step of allowing a base transceiver station corresponding to the cell to transmit a pilot signal and service zone partitioning information to each of said mobile stations and allowing each of said mobile stations to receive said pilot signal and service zone partitioning information transmitted from said base transceiver station, compare the received pilot signal with the received service zone partitioning information, determine from the compared result which one of said service zones corresponds thereto, and notify said base transceiver station of the determined service zone.

10. The method as set forth in claim 9, wherein said service zone partitioning information includes zone partitioning information based on a reception signal-to-noise ratio of each of said mobile stations with respect to said pilot signal transmitted from said base transceiver station, and wherein said step b) includes the step of allowing each of said mobile stations to calculate said reception signal-to-noise ratio with respect to said pilot signal and determine on the basis of the calculated result which one of said service zones corresponds thereto.

11. The method as set forth in any one of claims 1 to 6, wherein said step b) includes the step of determining which each of said mobile stations is located in any one of said service zones, on the basis of strengths of signals transmitted from said mobile stations after synchronization with a base transceiver station corresponding to the cell.

12. A method for managing resources in a wireless mobile communication system, comprising the steps of:
a) partitioning one cell into a plurality of service zones;
b) allowing a radio network controller allocating said resources to mobile stations, to determine which each of said mobile stations is located in any one of said service zones; and
c) allowing said radio network controller to allocate said resources and packet transmission priorities differentially to said mobile stations according to the determined service zones.

13. The method as set forth in any one of claims 1 to 12, wherein said resources include at least one of a transmission rate, transmission power and a transmission variation rate.

14. The method as set forth in claim 13, wherein said step c) includes the step of allocating a relatively high value of said transmission rate, transmission power or transmission variation rate to ones of said mobile stations located in any one of said service zones nearer to said base transceiver station.

15. A method for performing access by mobile stations in one cell, comprising the steps of:
a) partitioning said cell into a plurality of service zones;
b) determining which each of said mobile stations is located in any one of said service zones; and
c) allowing each of said mobile stations to determine initial access preamble signal power on the basis of associated service zone information and try randomly the access to a radio network controller with the determined initial access preamble signal power.
